(19) United States
(12) Patent Application Publication
(10) Pub. No.: US 2008/0277208 A1
(43) Pub. Date: Nov. 13, 2008

(54) Balanced actuator device and hoisting and transporting apparatus incorporating such device

(76) Inventor: Giuseppe Barone, Termini Imerese (IT)

Correspondence Address: MAROSCIA & ASSOCIATI S.R.L., Contra S. Caterina, 29, Vicenza, 36100, IT

(21) Appl. No.: 12/149,421

(22) Filed: May 1, 2008

(30) Foreign Application Priority Data
May 3, 2007 (IT) VI2007A000125

(51) Int. Cl. B66B 9/04

(52) U.S. Cl. 187/273

(57) ABSTRACT

The present application finds application in the technical field of the devices for hoisting and transporting loads and relates to a balanced actuator device for lifting and transporting apparatus comprises a bearing frame (3), means (4) for supporting an external load (L), substantially vertical guide means (5) associated with said frame (3) to guide said support means (4), drive means (6) operating on said support means (4) to move them along said guide means (5) by a predetermined stroke (c) between a lower end position (A) and a upper end position (B). The drive means (6) include at least one preloaded elastic actuator element (7) which is designed to exert a sufficient balancing force (F) on said support means (4) to hold the load (L) in an intermediate equilibrium position (C) between the upper (B) and lower (A) end positions thereby allowing minimization of the size of the drive means (6).

### FIELD OF THE INVENTION

The present invention finds generally application in the technical field of the devices for hoisting or lifting and transporting loads and specifically relates to a balanced lifting device for hoisting and transporting apparatus.

In accordance with a second aspect, the invention relates to an hoisting apparatus including the above device.

### BACKGROUND ART

Carriages and lifting and transporting devices for vertically carrying and/or positioning people and materials from the ground or a start level to a predetermined work height are known in the art.

Similar apparatus employ well-known conventional actuator devices, such as hydraulic or mechanical systems, e.g. rack/pinion or pulley systems.

US2007/0007082 discloses, for instance, an elevator apparatus in which an elevator platform is carried to various heights using a motor-driven helical screw.

This platform also has a carriage with four wheels mounted thereto, which are adapted to slide along a pair of vertical and parallel rails to guide the platform and turn the rotary motion of the helical screw into a translational motion of the platform.

These systems have the drawback of requiring a power peak at the start of the lifting step, which involves the need for high-power actuator means requiring, in the case of movable electric systems, batteries of considerable capacity. This involves a corresponding weight increase, requiring adequate structural dimensioning.

Furthermore, during the load lowering step, the actuator means shall be supplied with substantially as much power as is required for lifting.

Therefore, lifting apparatus of this type have a relatively high power consumption, particularly when handling considerable loads, which reduces their cost-effectiveness and life.

### SUMMARY OF THE INVENTION

The object of this invention is to overcome the above drawbacks, by providing a balanced actuator device for lifting and transporting apparatus that is highly efficient and relatively cost-effective.

A particular object is to provide an actuator device that can use considerably smaller drive means for the lifting and transporting apparatus associated therewith to perform a load handling cycle including lifting and lowering steps.

Another object is to provide a lifting and transporting apparatus of simple construction, involving lower management costs.

Yet another important object of the present invention is to provide a lifting and transporting apparatus having a long operating life.

These and other objects, as better explained hereafter, are fulfilled by a balanced actuator device as defined in claim 1, comprising a bearing frame, support means for an external load, substantially vertical guide means associated with said frame to guide the support means, drive means operating on said support means to move them along said guide means over a predetermined stroke between a lower end position and an upper end position.

The device is characterized in that the drive means include at least one preloaded elastic element to exert a sufficient balancing force on said support means to hold the load in an intermediate equilibrium position between said upper and lower end positions thereby allowing minimization of the size of said drive means.

Thanks to this particular configuration, the device of the invention allows a considerable reduction of the forces required during both the lifting step to reach the upper end position and the lowering step to reach the lower end position.

Infact, during the lifting step, the actuator element can provide part or all of the force required to move the load and particularly the part of energy required to move the load from the lower end position or start position, to the predetermined work position.

Similarly, during the lowering step, the drive means will only have to be actuated over the portion between the load equilibrium position and the lower end position, thereby allowing for a reduction of the drive means size.

In another aspect, the invention provides a load lifting and transporting apparatus comprising a balanced actuator device as defined in one or more of claims 1 to 14.

Thanks to the particular features of the invention, the apparatus may be equipped with components, such as batteries or motors, of smaller size as compared with similar known apparatus, and will be much more cost effective in terms of both construction and management and power consumption.

### BRIEF DESCRIPTION OF THE DRAWINGS

Further characteristics and advantages of the invention will be more apparent from the detailed description of a preferred, non-exclusive embodiment of a balanced actuator device and a lifting and transporting apparatus, which is described as a non-limiting example with the help of the annexed drawings, in which:

FIG. 1 is a front view of a first embodiment of a lifting and transporting apparatus comprising an actuator device of the invention;

FIGS. 2a and 2b are schematic views of a device of the invention in two distinct operating positions according to a first preferred configuration;

FIGS. 3a and 3b are schematic views of a device of the invention in two distinct operating positions according to a second preferred configuration;

FIGS. 4a and 4b are schematic views of a device of the invention in two distinct operating positions according to a third preferred configuration;

FIG. 5 is a schematic view of a device of the invention in a fourth preferred configuration;

FIG. 6 is a schematic view of a device of the invention in a fifth preferred configuration;

FIG. 7 is a schematic view of a device of the invention in a sixth preferred configuration;

FIG. 8 is a side view of a lifting and transporting apparatus in a second preferred configuration;

FIG. 9 is a sectional view as taken along the plane I-I of the apparatus of FIG. 8;

FIG. 10 is a rear view of the apparatus of FIG. 8.

### DETAILED DESCRIPTION OF A PREFERRED EMBODIMENT

Referring to the above figures, the device of the invention, generally designated by numeral 1, may be mounted to a load lifting and/or transporting apparatus of the stationary or movable type, generally designated by numeral 2, to assist it during lifting and/or lowering of one or more loads.

The connection of the device 1 with the apparatus 2 may be of either fixed or remountable type and may be disabled anytime, for the apparatus 2 to be used in a conventional manner.

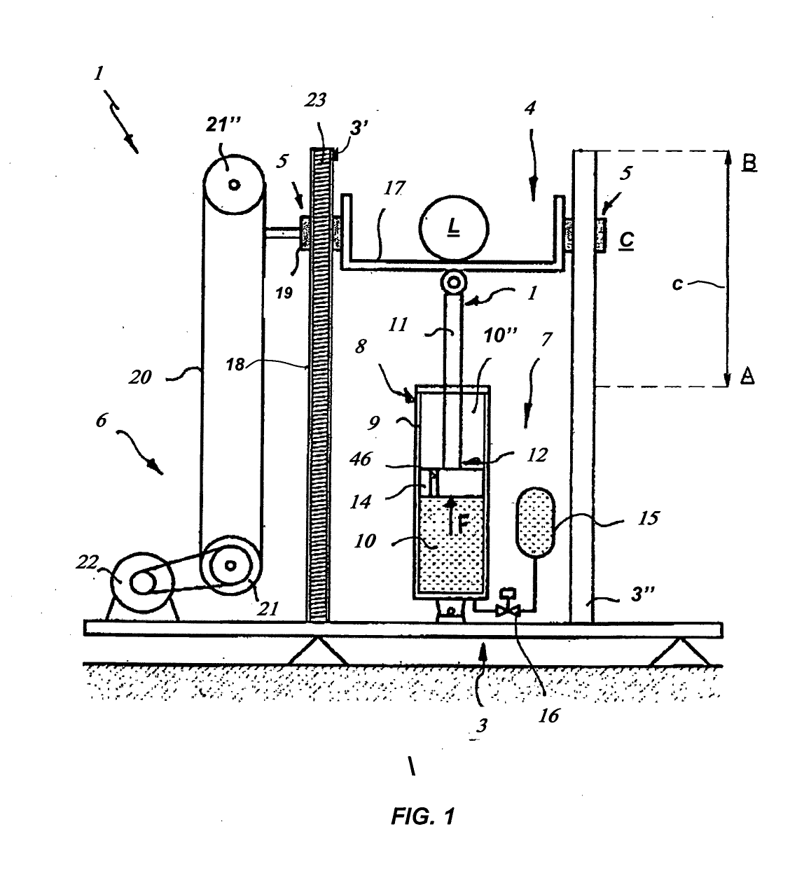

FIG. 1 schematically shows an actuator device 1 that comprises a bearing frame 3, support means 4 for an external load L, substantially vertical guide means 5 associated with the frame 3 to guide the support means 4 and drive means 6 operating on the support means 4 to move them along the guide means 5 over a predetermined stroke c between a lower end position A and an upper end position B.

According to a particular characteristic of the invention, the drive means 6 include at least one preloaded elastic actuator element 7, which is designed to exert a balancing force F, as designated by the arrow, on the support means 4 during at least part of the stroke c, which force is sufficient to hold the load in an intermediate equilibrium position C between the upper B and lower A end positions.

Thus, the operation of the drive means 6 may be minimized both when the load L is lifted and when it is lowered.

Particularly, the preload of the elastic element 7 may be selected in such a manner that the intermediate position C is close to or possibly coincident with one of the upper end B and lower end A positions.

Nonetheless, the position C that corresponds to the equilibrium between the weight of the load L and the balancing force F may advantageously be proximate to half of the stroke c.

Thus, the drive means 6, that may consist of an ordinary electric motor, shall only operate over half of the stroke c during both the lifting and lowering steps.

In a particular configuration, not shown, the actuator element 7 may essentially consist of one or more helical springs made of steel or another common metal alloy or an elastomeric material, appropriately preloaded and slideably accommodated in respective cylindrical housings.

In an alternative embodiment, the actuator element 7 may be a gas spring 8 loaded with a gas at a predetermined pressure, so as to produce the force F.

It shall be nonetheless understood that more than one spring 8 may be used and particularly a combination of helical springs, gas springs or other types of springs having substantially the same operation as those mentioned above, and preloaded with the same initial load, may be used at the same time.

The gas spring 8 may be of the commonly available type and may essentially consist of a cylindrical sleeve 9 that defines an inner working chamber 10 with compressed gas contained therein.

A rod 11 may be slideably and sealingly held within the sleeve 9, with an end 12 moving in the working chamber 10 and the opposite end 13 associated with the support means 4 for the load L.

Therefore, the rod 11 and the inner wall of the cylindrical sleeve 9 may define a variable-pressure working chamber 10, containing compressed gas, such as nitrogen or any other gas having adequate compressibility.

Thus, pressure variation within the sleeve 9 will be caused by a change of volume of the working chamber 10 due to various extents of penetration of the rod 11.

Also, the rod 11 may have a plunger 14, at its end 12 inside the cylinder 9, for dividing the working chamber 10 into two areas 10′, 10″ and for guiding the rod 11 during its stroke c.

Advantageously, the plunger 14 may have a hole 46, possibly but without limitation calibrated for controlled passage of gas from one area 10′ to the other 10″ and vice versa of the working chamber 10, to allow the rod 11 to slide within the chamber 9.

The gas spring 8 may receive gas from an external tank 15 connected to the working chamber 10, e.g. via a mechanical or solenoid valve 16, that is used for automatically and/or manually adjusting the predetermined gas pressure.

Thus, a predetermined intermediate position C may be selected, i.e. the position in which the equilibrium of the load L is only ensured by the balancing force F exerted by the gas through the rod 11, for the drive means 6 to only operate over the stroke portion between the intermediate position C and the end positions A and B.

In a preferred non-limiting embodiment of the invention, the support means 4 for the load L may include a platform 17 susceptible of supporting the external load L.

Preferably, the guide means 5 may include a substantially straight guide 18 associated with the frame 3 that may in turn consist of one or more pairs of vertical and parallel rails 3′, 3″ for a slide or car 19 integral with the platform 17 to be slideably mounted thereto.

The drive means 6 designed to transfer motion to the support means 4 may be of traditional type, e.g. selected from the group comprising actuators of pneumatic, hydraulic, gas-operated, electric, electromechanical types, or a combination thereof.

In one particular embodiment, also shown in FIG. 1, the drive means 6 may be of mechanical type, with a belt, chain or the like 20 extending in a closed loop over at least one pair of tension pulleys 21′, 21″.

The belt or chain 20 may be connected in a known manner to a bracket, not shown, and at least one of the pulleys 21′, 21″ may be operably coupled to a run motor 22, such as a battery-operated motor, or manually driven.

Otherwise, the belt may have an open-loop configuration, and be wound around the roller of a winch, not shown.

One or more substantially vertical worms 23, associated with corresponding rails 3′, 3″ of the frame 3 and coupled to a gearmotor, not shown, may be also provided for cooperation with a nut screw or a similar member, also not shown but known per se, connected to the platform 17, i.e. mounted to the slide 19.

By this arrangement, the helical motion of the screws 23 may be turned into translational motion for lifting or lowering the load L on the platform 17.

Otherwise, the mechanical drive means 6 may include a rack transmission 24 composed of a gear wheel 25 driven by a gearmotor, not shown, and coupled to a rack 26 to be associated with the platform 17.

The mechanical drive means 6 may be combined with additional hydraulic and/or gas-operated drive means 6, e.g. comprising one or more jacks 27, 27′ to be connected to a pump or source of a pressurized fluid 28.

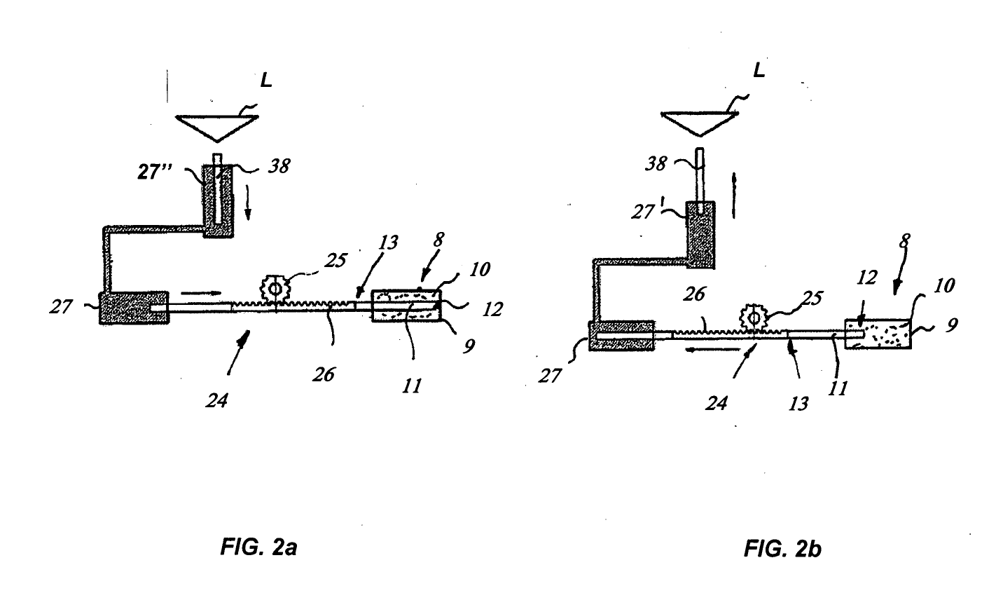

FIGS. 2a and 2b schematically show a configuration in which the device 1, that is shown in two different operating positions, may include a pair of synchronized hydraulic jacks or gas jacks 27, 27′, although the latter may be also provided in greater number and not necessarily of similar type, which jacks are driven by the horizontally extending gas spring 8 with the interposition of mechanical drive means 6.

This configuration does not require a pump or source of pressurized fluid 28, because such action is exerted by the gas spring 8 or by any other suitable type of spring.

Thanks to the particular configuration of the device 1, pressure within the jacks 27, 27′ will be always constant, regardless of the position of the rod 38, whereas pressure within the gas spring 8 will change according to the depth of penetration of the rod 38.

The drive means 6 may consist of a rack transmission 24, as shown, or an equivalent mechanical actuator, such as a worm, a cable winch or similar actuators.

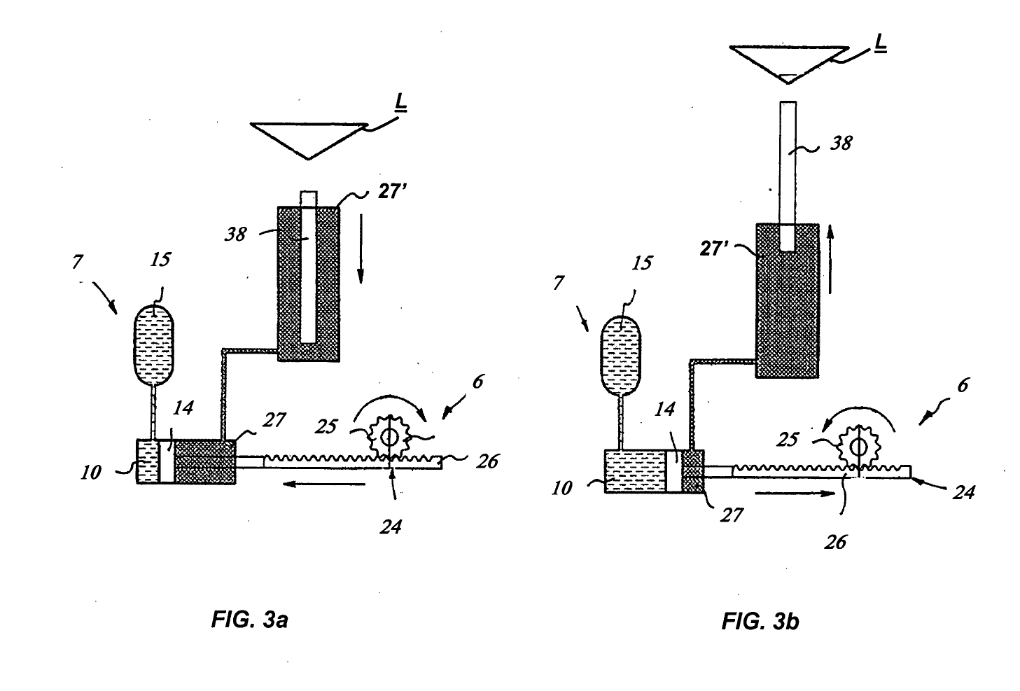

In the configuration as shown in FIGS. 3a and 3b, the gas spring 8 will be replaced by a working chamber 10 directly associated with the drive means 6 and connected to a tank 15 that acts as a backpressure gas tank at a sufficient predetermined pressure to exert the balancing force F.

In both of these configurations, the rod 38 of the vertical hydraulic jack 27′ may have such a size as to define a volume that substantially coincides with the volume of the working chamber 27.

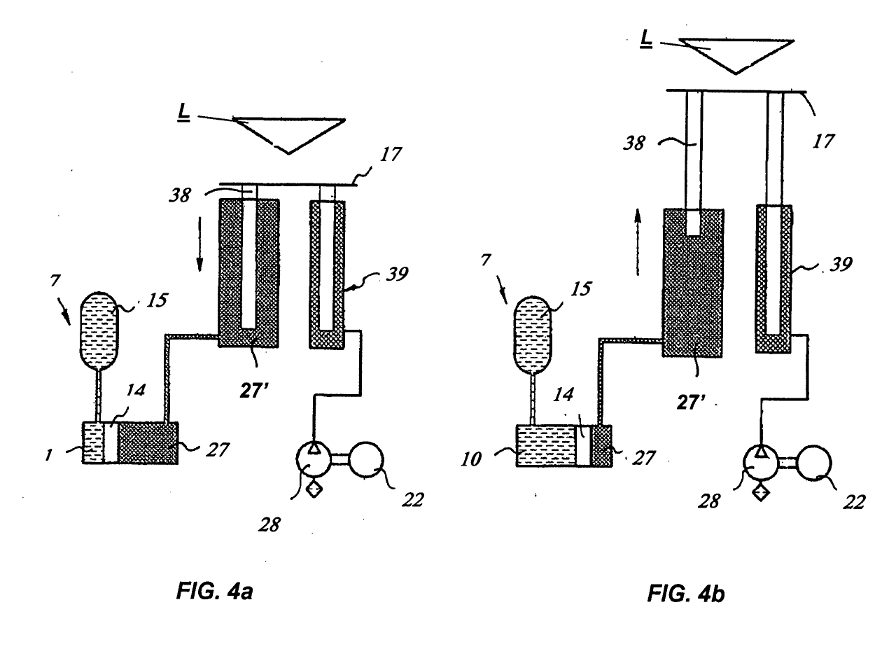

FIGS. 4a and 4b show another mixed configuration in which the device 1 of the configuration of FIG. 3 is further equipped with an additional auxiliary jack 39 that is supplied with pressure by a pump or another pressure source 28 driven by a motor 22.

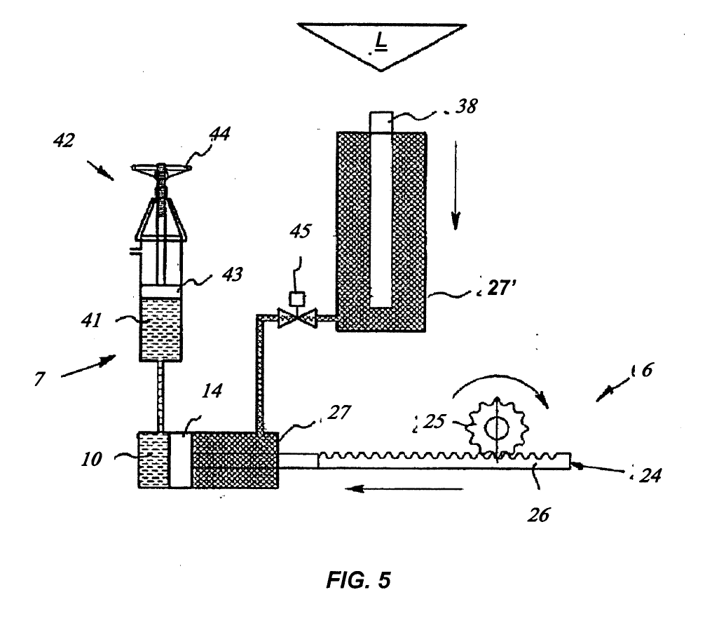

FIG. 5 shows one more preferred configuration of the invention in which the working chamber 10 is not connected to the backpressure tank 15 but may be in fluid communication with a second chamber 41 having automatic or manual pressure-regulating means 42, such as a plunger 43 actuated by a knob 44.

A valve 45 is used to stop oil supply into the jack 27′, thereby locking the rod 38 at a predetermined position of the load L.

This will ensure stability of the device 1, thereby avoiding any springing effect caused by the inherent elasticity of the gas or other elastic element 7, in case of moving loads.

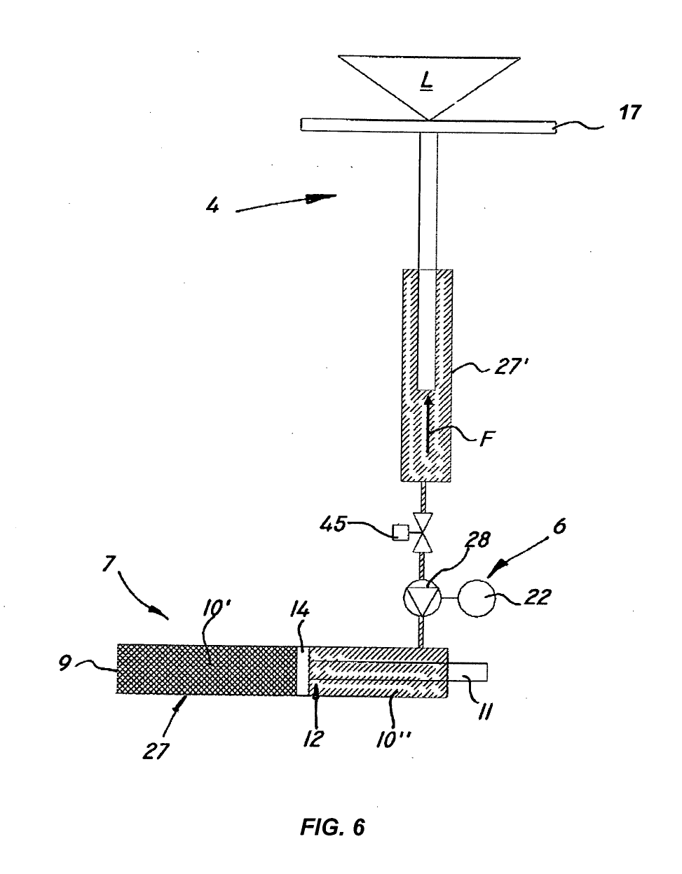

FIG. 6 shows another configuration of the device 1 of the invention, in which fluid passage between the area 10″ of the working chamber 10 of the horizontal jack 27 and the vertical jack 27′ is ensured by means of a pump 28 driven by the motor 22.

Here again, a back pressure will be exerted on the plunger 14 of the jack 27 by fluid contained in the area 10′ of the working chamber 10.

The solenoid valve 45 will stop the flow between the two jacks 27, 27′, thereby locking the platform 17 in the predetermined position.

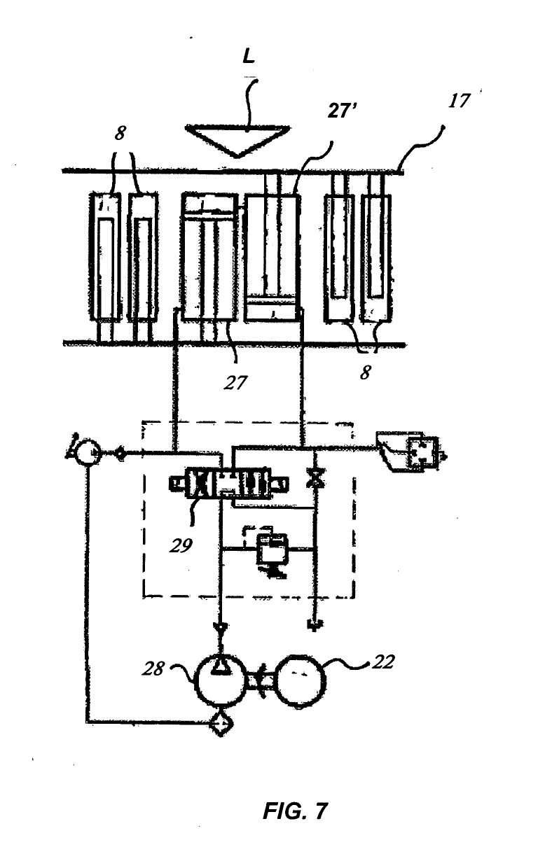

FIG. 7 is a schematic view of a device 1 of the invention, in which a pair of synchronized hydraulic jacks 27, 27′ cooperate to move the lifting platform 17.

Several gas springs 8 may be provided, e.g. four as shown or more or less than four, in vertical arrangement for assisting the drive means 6 throughout the cycle for handling the load L or during a part of such cycle.

Thus, the jacks 27, 27′ will provide a telescopic effect, so that their overall maximum extension is sufficient to cover the whole predetermined stroke c.

In a configuration that is not shown, both the hydraulic and/or gas jacks 27, 27′, . . . and the gas springs 8 may be provided in coaxial arrangements to define a plurality of telescopic sections designed to be selectively operated by the valve 29, eventually a solenoid valve, to move the load L to respective intermediate positions C corresponding to respective predetermined values of the force F exerted by the actuator element 7.

It shall be nonetheless understood that in all configurations as described and illustrated herein, one or more of the gas springs 8 or the assembly composed of the tank 15 and the pair of working chambers 10 and 41 may be replaced by any other actuator element 7 of or equivalent to the above described type, without departure from the scope of the present invention.

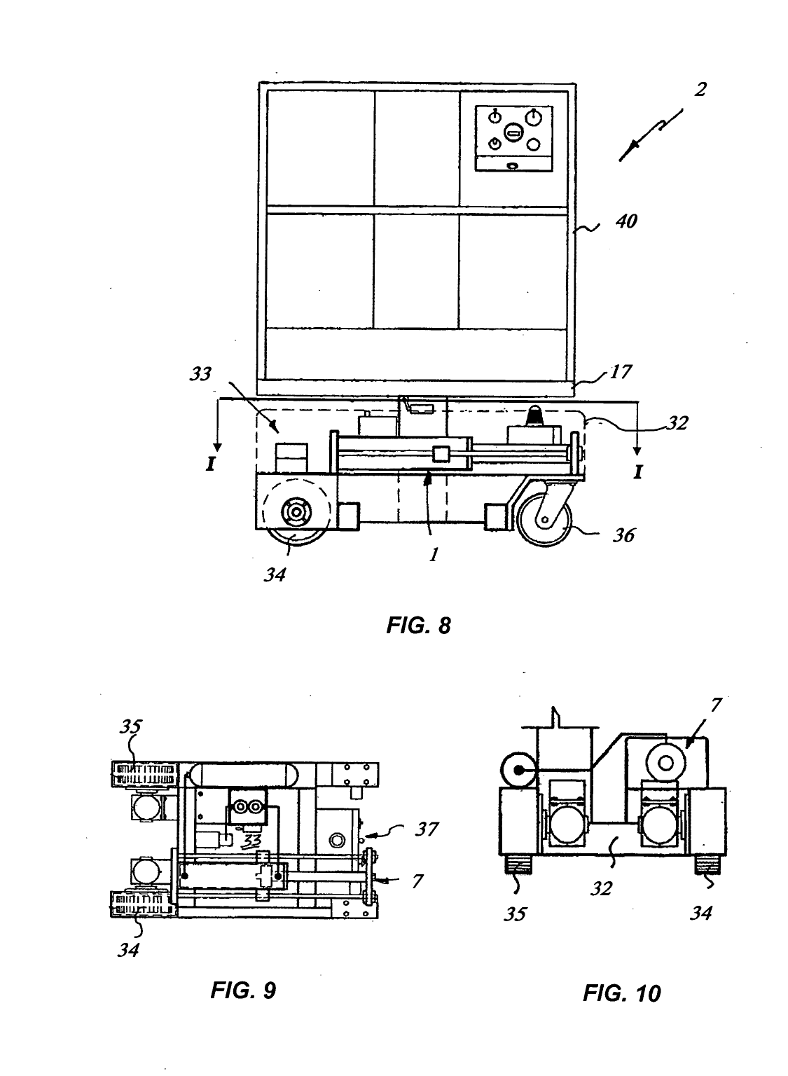

FIGS. 8 to 10 show an apparatus for lifting and transporting loads 2 that employs an actuator device 1 as described hereinbefore.

The apparatus 2 comprises a support frame 32 defining an inner housing 33 for the actuator device 1. The frame 32 stands on wheels, such as a pair of motorized rear rubber wheels 34, 35 and a pair of front wheels 36 associated with steering means 37 that can be controlled to drive the apparatus 2 and control its displacement over a floor or a roadway.

For instance, the apparatus 2 may be useful to transport an operator within the upper cage 40 associated with the device 1 at the periphery of the platform 17.

In operation, assuming that a device 1 of the invention has a working cycle with steps for lifting and lowering a load L, appropriate selection of a spring 8 or a set of springs or other elastic elements 7 will cause the load L to be lifted, possibly by an operator standing on the platform, to a predetermined working height corresponding to the condition of equilibrium between the weight of the load L and the balancing force F exerted by the elastic element 7.

This first part of the cycle will be carried out using the energy stored within the elastic actuator element 7 without employing the drive means 6, such as a motor.

In the stroke position c between the intermediate position C and the upper end-of-stroke position B, the drive means 6 shall not only overcome normal frictions, but shall also exert a force corresponding to the difference between the pressure within the sleeve 9 when the load L is in the upper end position B and the pressure required to move the rod 11 to the intermediate position.

During the lowering stroke, the device 1 shall exert no force in the stroke portion between the upper end position B and the intermediate position C because the load L will fall by gravity.

However, from the intermediate position C to the lower end position A the drive means 6 shall not only overcome frictions, but shall also exert a force corresponding to the difference between the pressure within the cylindrical sleeve 9 exerted on the base of the rod 11, with the latter in the intermediate position C, and the pressure with the base of the rod 11 in the bottom end position A.

Here again a downward force shall be exerted to counteract the energy stored within the elastic element 7.

As the rod 11 enters the sleeve 9, it will reduce the volume of the working chamber 10 to the gas contained therein, and will compress such gas thereby increasing its pressure.

Therefore, throughout the cycle for lifting and lowering the load L, the overall required force will be lower than required in a traditional system with a hydraulic power unit and a corresponding hydraulic cylinder.

The above clearly shows that the invention fulfills the intended objects and particularly meets the requirement of providing a balanced actuator device in which passive balancing force elements in the form of one or more elastic elements 7 allow the lifting and transporting apparatus with which the device 1 may be associated to use motors and other mechanical energy sources that are undersized in terms of power to be delivered, as compared with the same apparatus without such device.

For instance, this allows use of a smaller number of batteries or lower power motors, that are smaller and quieter, which involves considerable advantages in terms of weight and size reduction of the whole structure and hence considerable cost savings.

The device and apparatus of this invention are susceptible to a number of changes or variants, within the inventive concept disclosed in the appended claims. All the details thereof may be replaced by other technically equivalent parts, and the materials may vary depending on different needs, without departure from the scope of the invention.

While the device and apparatus have been described with particular reference to the accompanying figures, the numerals referred to in the disclosure and claims are only used for the sake of a better intelligibility of the invention and shall not be intended to limit the claimed scope in any manner.

1. A balanced actuator device for lifting and transporting apparatus comprising:
a bearing frame (3);
support means (4) for an external load (L);
substantially vertical guide means (5) associated with said frame (3) to guide said support means (4);
drive means (6) operating on said support means (4) for moving them along said guide means (5) over a predetermined stroke (c) between a lower end position (A) and an upper end position (B);
characterized in that said drive means (6) include at least one preloaded elastic actuator element (7) for exerting a sufficient balancing force (F) on said support means (4) to hold the load (L) in an intermediate equilibrium position (C) between the upper (B) and lower (A) end positions thereby allowing minimization of the size of such drive means (6).

2. Actuator device as claimed in claim 1, characterized in that said at least one elastic element (7) includes at least one gas spring (8) having a substantially cylindrical sleeve (9) loaded with a gas at a pressure regulated to a predetermined value, such as to produce said balancing force (F) and in which a rod (11) is slideably held, which defines with the inner wall of said cylindrical chamber (9) a variable-volume working chamber (10) for said compressed gas.

3. Actuator device as claimed in claim 2, characterized in that said rod (11) is integral with a guide plunger (14) sliding in a substantially sealable manner in said sleeve (9).

4. Actuator device as claimed in claim 3, characterized in that said working chamber (10) is directly associated with said drive means (6) and is in fluid communication with a tank (15) for supplying a gas at a sufficient predetermined pressure to exert said balancing force (F).

5. Actuator device as claimed in claim 1, characterized in that said at least one elastic element (7) includes at least one preloaded helical spring or is made of an elastomeric material, slideably accommodated in a cylindrical housing.

6. Actuator device as claimed in claim 1, characterized in that said support means (4) include a platform (17) susceptible of supporting an external load (L), said platform (17) being integral with said guide means (5).

7. Actuator device as claimed in claim 1, characterized in that said drive means (6) are selected from the group comprising actuator means of the pneumatic, hydraulic, fluid-dynamic, gas-operated, electric, electromechanical type or a combination thereof.

8. Actuator device as claimed in claim 7, characterized in that said mechanical drive means (6) include a belt, chain or the like (20) extending in a closed loop over at least one pulley or roller (21′, 21″) and a bracket for locking one point of said belt or chain or the like (20), said at least one pulley or roller (21′, 21″) being operably coupled to a drive motor (22).

9. Actuator device as claimed in claim 7, characterized in that said mechanical drive means (6) include a worm (23) coupled to a gearmotor and designed to cooperate with a nut screw or an equivalent member integral with said platform (17).

10. Actuator device as claimed in claim 7, characterized in that said mechanical drive means (6) are of the rack and pinion type (24) with a gearwheel (25) coupled to a gearmotor and a rack (26) coupled to said platform (17).

11. Actuator device as claimed in claim 7, characterized in that said fluid-dynamic drive means (6) include at least one hydraulic or gas jack (27, 27′) driven by said elastic element (7) with the interposition of said mechanical drive means (6).

12. Actuator device as claimed in claim 11, characterized in that said at least one hydraulic or gas jack (27) is connected to a pump or source of compressed fluid (28).

13. Actuator device as claimed in claim 1, characterized in that said mechanical drive means (6) associated with said fluid-dynamic drive means (6) include a kinematic pair of the rack and pinion type mounted to a drive motor.

14. Actuator device as claimed in claim 2, characterized in that said gas spring (8) is of the telescopic type, for its maximum extension to be sufficient to wholly cover said predetermined stroke (c).

15. A load lifting and transporting apparatus comprising a balanced actuator device (1) and a bearing frame (32) that defines a housing (33) therein for said actuator device (1), wherein said balanced actuator device (1) is of the type as claimed in claim 1.

16. Apparatus as claimed in claim 15, characterized in that said bearing frame (32) stands of wheels (34, 35, 36), including at least one motorized wheel and comprises at least one steering pair (37) to facilitate handling of said apparatus over a floor or a roadway.
